(19) United States
(12) Patent Application Publication
(10) Pub. No.: US 2002/0081878 A1
(43) Pub. Date: Jun. 27, 2002

(54) Twistable connector and provider assembly

(76) Inventor: Mark Bruno, Ronkonkoma, NY (US)

Correspondence Address: Mark Bruno, 197 Rastic Road, Ronkonkoma, NY, 11779, US

(21) Appl. No.: 09/748,880

(22) Filed: Dec. 27, 2000

(51) Int. Cl. H01R 3/00

(52) U.S. Cl. 439/164

(57) ABSTRACT

A twistable electrical connector for computer periphery devices in the form of an interface which allows the user to turn the connector at least ninety degrees, such that one can fit the device into places a standard connector will not fit. A left part of the device functions as a standard connector, and a right part contains a retaining disk integrated into the section that is generally rear of a standard connector. The retaining disk functions to maintain connector integrity while allowing the left and right sections to rotate at least ninety degrees with respect to one another. In the preferred mode, a flexible, semi-rigid plastic pipe separates the diversified connector types and extends the twistable connector. Both ends could be any type of interface, as determined by items required. The twistable connector may engage a provider that represents a type of interface connector or advanced design of the typical connector. The provider may consist of a hub base with suction cups affixed to the bottom thereof. The side of the base contains several ports to receive connectors. Twistable connectors may be inserted into the ports as an extension or destination. Thus, the provider allows for multiple connections, and can be conveniently adhered to a flat surface that is optimal for user accessibility, wire minimization, and organization. The provider may bear graphics thereon, creating an aesthetically pleasing item that enhances the decor of the overall system.

### BACKGROUND OF THE INVENTION

1. Field of the Invention

The present invention is a twistable electrical connector for computer periphery devices. More particularly, the present invention is an interface which allows the user to turn the connector at least ninety degrees, such that one can fit the device into places a standard connector will not fit. A left part of the device functions as a standard connector, and a right part contains a retaining disk integrated into the section that is generally rear of a standard connector. The retaining disk functions to maintain connector integrity while allowing the left and right sections to rotate at least ninety degrees with respect to one another. In the preferred mode, a flexible, semi-rigid plastic pipe separates the diversified connector types and extends the twistable connector. Importantly, if the twistable connector is used alone, both ends could be any type of interface, as determined by items required.

The twistable connector may engage a provider device that represents a type of interface connector or advanced design of the typical connector. In the preferred mode, the provider device consists of a hub base with suction cups or other means of adhesion affixed to the bottom of the device. The side portion of the base contains several ports to receive connectors. Twistable connectors may be inserted into the ports on the side of the base as an extension or as a destination. Thus, the provider device allows for multiple connections, and can be conveniently adhered to a wall or flat surface that is optimal for user accessibility, wire minimization, and general neatness and organization. Finally, the provider device may bear graphics or design elements thereon, creating an aesthetically pleasing item that enhances the decor of the overall system.

2. Description of the Prior Art

Numerous innovations for connectors have been provided in the prior art that are described as follows. Even though these innovations may be suitable for the specific individual purposes to which they address, they differ from the present invention as hereinafter contrasted. The following is a summary of those prior art patents most relevant to the invention at hand, as well a description outlining the differences between the features of the present invention and those of the prior art.

1. U.S. Pat. No. 4,586,763, invented by Paulsen et al. entitled “Rotatable Connector Mechanism”

In the patent to Paulsen et al., a connector component for computer units and peripheral units is secured to the back of each unit and enables the units to be stacked together in direct electrical connection, without the need for cables between them. Each connector component includes a pair of swivel mounts which rotate through 90 degrees and support a multi-contact pin connector, so that each connector can be oriented either vertically or horizontally, toward the rear of the unit. The pin connectors are internally connected to the operable portions of each unit by an internal cable bus. For direct interconnection between units, the adjacent swivel mounts are rotated to the vertical position and mated. At the top and bottom of a vertical stack of units, the extreme upper and lower swivel mounts may be rotated to the horizontal, rearward-facing position for connection to a cable leading to other computer or peripheral units remote from the stack.

2. U.S. Pat. No. 5,227,957, invented by Deters entitled “Modular Computer System With Passive Backplane.”

In the patent to Deters, a modular computer chassis with passive backplane is provided for a personal computer system with a plurality of open-ended and vertically or horizontally interconnectable bays, or a single case with bays, for slidably receiving component trays each having a printed double sided bus direction adapter board with a bus connector at one end and a female bus connector mounted to the top surface for attaching an expansion card parallel to the board. The end bus connector extends through the back wall of the tray to connect to a female bus connector on a passive backplane connector board attached to the back of the chassis. The adapter board converts the established bus connection between the card and female bus connector 90 degrees to the bus connector at the rear of the tray. A front cover, or individual tray covers, cover the front of the chassis as a locking and security mechanism. The bays connect and hold standard off-the-shelf personal computer components, and additional bays may be added and connected to the system, or used at remote locations, by means of an external cable harness or cable connector which attaches to the backplane board.

3. U.S. Pat. No. 5,822,182, invented by Scholder et al. entitled “Flexible I/O Port Configuration And Connector Labeling Scheme For Computer Chassis”

The patent to Scholder et al. describes a flexible I/O port configuration and connector labeling scheme for a computer chassis. An I/O shield that includes connector cutouts specific to a system motherboard is attached to the system motherboard. The motherboard to which the I/O shield is attached may be installed in a generic chassis that includes cutouts for “standard” connectors, such as VGA, keyboard, audio and mouse connectors, as well as a flexible I/O cutout for receiving custom connectors, such as USB and network connectors. Any connector cutout or portion of a cutout provided in the chassis through which a connector does not extend is filled by the I/O shield. In another aspect, an I/O labeling strip on which are printed icons for identifying the various connectors is press-fit onto the chassis, such that the strip can be easily removed and replaced. Each strip is provided with an alignment code that corresponds to an alignment code stamped on the I/O shield and visible through an unused or partially used cutout of the chassis such that, when the strip is properly positioned relative to the chassis, the codes are also aligned with one another.

4. U.S. Pat. No. 5,761,447, invented by Knox et al., entitled “Adapter Connection Apparatus For Simultaneously Connecting A Plurality Of Adapters To Diverse Bus Architectures”

The patent to Knox et al. describes an adapter connection apparatus for a data processing system having at least first and second bus architectures and a guide for receiving first and second removable adapters. Within the guide, first and second electrical contacts are provided for simultaneously connecting the first and second adapters to the first and second bus architectures, respectively.

5. U.S. Pat. No. 5,751,559, invented by Jensen et al., entitled “Apparatus For Inserting PC Cards Having Recessed Guide Paths With Multiple Levels In The Guide Paths”

The patent to Jensen et al. describes an apparatus capable of housing PC cards including a PC card with a connector and PC card guide, a housing having an insertion opening for inserting the PC card and a circuit board mounted in the housing. The connecting direction between the PC card and the circuit board is perpendicular to the insertion direction of the PC card. The apparatus further includes guides arranged on the housing having two cam plates which are separated by spacers and supported by a shaft. Each cam plate has a continuously recessed guide path for guiding the PC card. The guide path has a guiding portion and a stop portion wherein the transition of the pivot pin from the guiding portion to the stop portion causes a defined rotation of the plug-in package about the pivot point wherein the plug-in package is rotatably arranged at the pivot point. This allows the PC card to make a pivot motion in order to accomplish the connection between the plug-in package and the circuit board.

6. U.S. Pat. No. 5,535,093, invented by Noguchi et al., entitled “Portable Computer Docking Device Having A First Rotatable Connector And A Second Connector”

In the patent to Noguchi et al., a docking device for a portable computer which can be utilized with a number of portable computers having diverse sizes is disclosed. The docking device includes a body having a number of electronic components disposed therein adapted to be electrically connected to a portable computer. A surface supported by the body is adapted to slidably receive a portable computer selected from among the number of portable computers having diverse sizes. Adjacent to the surface, at least two electrical connectors are disposed, including a first connector rotatably supported by the body which is rotatable between a first position and a second position. The selected portable computer may be electrically connected to the number of electrical components via only the first electrical connector when the first electrical connector is in the first position and may be electrically connected to the number of electronic components via only the second electrical connector when the first electrical connector is in the second position. In a preferred embodiment, the surface is a tray which slides between a docked position at which the selected portable computer is electrically connected to the electronic components via one of the electrical connectors and an undocked position at which the selected portable computer is disconnected from the electronic components. According to a preferred embodiment, when the first electrical connector is in the first position, the first electrical connector extends further from the body along the direction in which the tray slides than the second electrical connector.

7. U.S. Pat. No. 4,641,098, invented by Steffinger, entitled “Right-Angled Plug-Type Connector”

The patent to Steffinger describes a right-angled plug-type connector for a printed circuit board connection characterized by a flexible fixing plate being secured in a plate-shaped retaining member to extend at right angles to the retaining member and having a plurality of bores in a pattern corresponding to a pattern of bores in the retaining member to receive contact elements which have a right angle bend. To improve the guidance of the contact elements which extend past a first side of the fixing plate to form contact prongs, each of the bores has a tubular extension which extends from a second side of the fixing plate. The tubular extensions improves the guidance and positioning of each of the prongs to prevent skewing or misalignment during the forming of a plug connection.

8. U.S. Pat. No. 5,540,597, invented by Budman et al., entitled “All Flex PCMCIA-Format Cable”

The Budman et al. invention describes a flexible cable assembly for coupling an electronic apparatus, having a port for receiving personal computer cards in accordance with the PCMCIA standard, to at least one peripheral device, said flex cable assembly comprises a personal computer card connector, in accordance with the PCMCIA standard, for connecting into a corresponding port in the electronic apparatus, and a flexible cable connected to the personal computer card connector. The personal computer card connector also comprises an interface to said at least one peripheral device. In accordance with a further aspect of the invention, the flex cable assembly can also couple a first electronic apparatus, to a second electronic apparatus, each having a port for receiving personal computer cards in accordance with the PCMCIA standard. This flex cable assembly comprises a first PCMCIA card connector for connecting into a corresponding port in either the first or second electronic apparatus; a second PCMCIA card connector for connecting into a corresponding port in either the first or second electronic apparatus; and a flex cable coupled between the first and second personal computer card connectors.

9. U.S. Pat. No. 5,923,802, invented by Giebel et al., entitled “Flexible Connector Assembly Having Slack Storage”

The Giebel et al. patent describes a partially flexible connector assembly and includes a slack storage tube connected to the first end of a fiber optic cable for loosely storing excess lengths of the optical fibers. The slack storage tube is typically at least partially flexible. By including a flexible slack storage tube, the connector assembly can be readily flexed, such as during installations of the fiber optic cable in which the end portion of the fiber optic cable must be bent relatively sharply. However, the slack storage tube does generally include crush resistance means for supporting the slack storage tube as the connector assembly is flexed such that the longitudinal bore defined by the slack storage tube remains open. The crush resistance means can include a wire helically wound about the slack storage tube. Alternatively, the slack storage tube can be a corrugated tube. The connector assembly also includes a number of ferrules mounted on the end portions of respective optical fibers as well as a ferrule holder for holding the ferrules in respective predetermined positions. In addition, the connector assembly can include a plug connected at a first end to the slack storage tube and having a second end that is adapted to receive and engage the ferrule holder. By disposing the ferrule holder within the second end of the plug, the plug effectively secures the ferrule holder and, in turn, the ferrules to the slack storage tube so as to form the connector assembly.

10. U.S. Pat. No. 4,673,234, invented by Lewis, entitled “Connector/Adapter Assembly For Flexible Conduit Or Electrical Cable”

The Lewis invention describes an assembly for use in coupling a flexible conduit or electrical cable to an electrical connector when the assembly and the connector must be clocked due to the fact that the conduit or cable cannot be twisted or rotated about its central axis. The assembly includes an adapter body adapted to be coupled to the conduit or cable and a nut rotatably mounted on an adjacent end of the body, the nut having threads for coupling the body to a connector to complete the assembly. The connector is adapted to be coupled to a panel-mounted connector or to a connector coupled to a second conduit or electrical cable. The body has a clocking ring rotatably mounted within one end of the body, the ring being held against axial removal from the body and being rotatable through a limited arc. The two connectors can readily mate with each other by merely rotating the clocking ring until proper clocking alignment is assured. The clocking ring thereby permits a predetermined rotational tolerance while avoiding the need to rotate the conduit or cable which would damage or destroy the electrical wire leads in the conduit or cable.

As outlined above, the relevant prior art patents mostly describe items that facilitate the stacking of computer peripheral components, the labeling of connectors for user convenience, guide members for connectors and PC cards, right-angled plug-type connectors, and several devices designed specifically for portable computer connection and accessibility.

In contrast to all of the above, the present invention is a twistable connector which allows the user to turn the connector at least ninety degrees to fit it into places standard connectors can not. A retaining disk integrated into the section rear of a standard connector maintains connector integrity and allows left and right sections to rotate at least ninety degrees with respect to one another. A flexible plastic pipe separates the connector types and extends the twistable connector for user convenience.

The twistable connector may engage a provider that consists of a hub base with adhesion means at the bottom of the device. Twistable connectors may be inserted into ports on the side of the base as an extension or as a destination. Thus, the provider device allows for multiple connections, and convenient placement for accessibility, wire minimization, and organization. Finally, the provider device may bear graphics thereon for aesthetic purposes.

### SUMMARY OF THE INVENTION

As noted above, the present invention is a twistable electrical connector for computer periphery devices. More particularly, the present invention is an interface which allows the user to turn the connector at least ninety degrees, such that one can fit the device into places a standard connector will not fit.

In light of the foregoing, it is an object of the present invention to provide an assembly that is relatively inexpensive to manufacture.

It is a further object of the invention to provide a device that encourages the user to utilize additional computer components, due to the convenience and ease created by the invention.

It is a further object of the invention to provide an assembly that may utilize any of a variety of connector and interface types, providing the user with great versatility.

It is also an object of the present invention to teach the usage of an assembly that is safe for the user to operate, providing greater versatility for the user.

It is a further object to provide an assembly that may be easily retrofitted to or used in conjunction with a host of previously-existing computers and peripheral components, providing significant benefits to all users.

In addition, it is an object of the present invention to provide an assembly that may be produced and sold with new computers and peripheral devices for the users' convenience.

It is also an object of the invention to allow for the twistabe connector to be used in conjunction with a provider device, which provides a means for multiple connections, convenient attachment to a wall or flat surface, wire minimization, and general neatness and organization.

It is an additional object of the invention to provide components that may bear graphics or design elements thereon, to create an aesthetically pleasing appearance that enhances the decor of the overall system.

The novel features which are considered characteristic for the invention are set forth in the appended claims. The invention itself, however, both as to its construction and its method of operation, together with additional objects and advantages thereof, will be best understood from the following description of the embodiments when read and understood in connection with accompanying drawings.

### BRIEF DESCRIPTION OF PREFERRED EMBODIMENTS

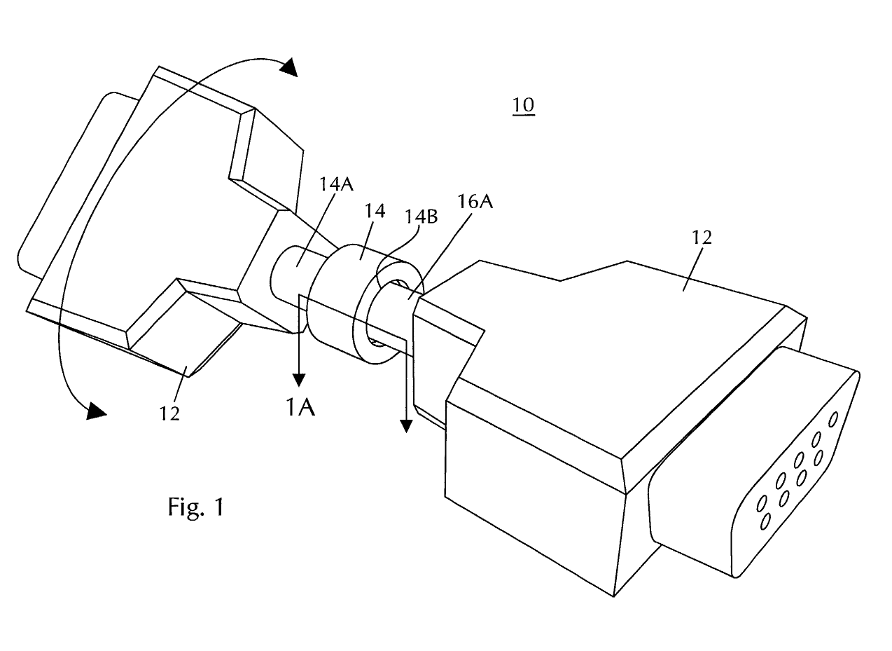

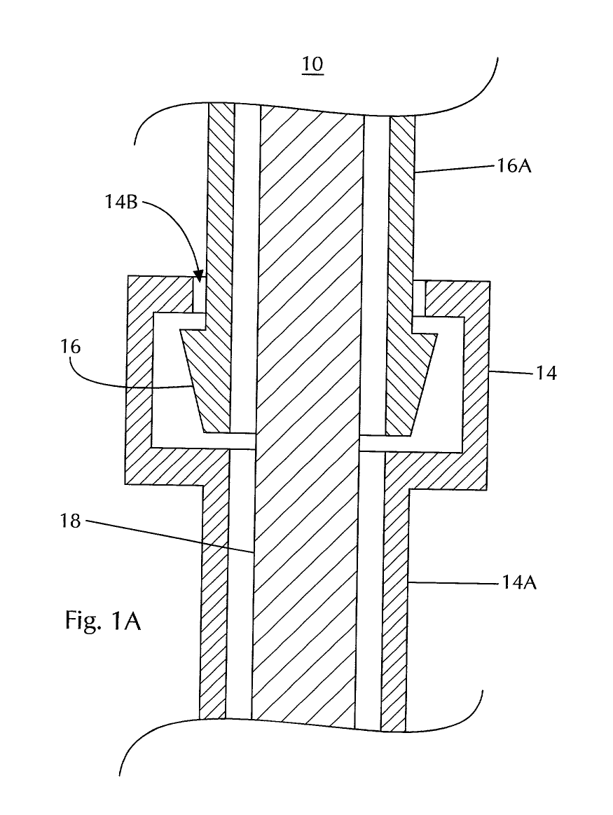

FIG. 1 is a three-quarter side perspective view of connection members in an assembled position, utilizing the rotation means of present invention, per the directional arrows located on the left side of the drawing.

FIG. 1A is a cutaway view of the connection members in an assembled position along line “1A” of FIG. 1.

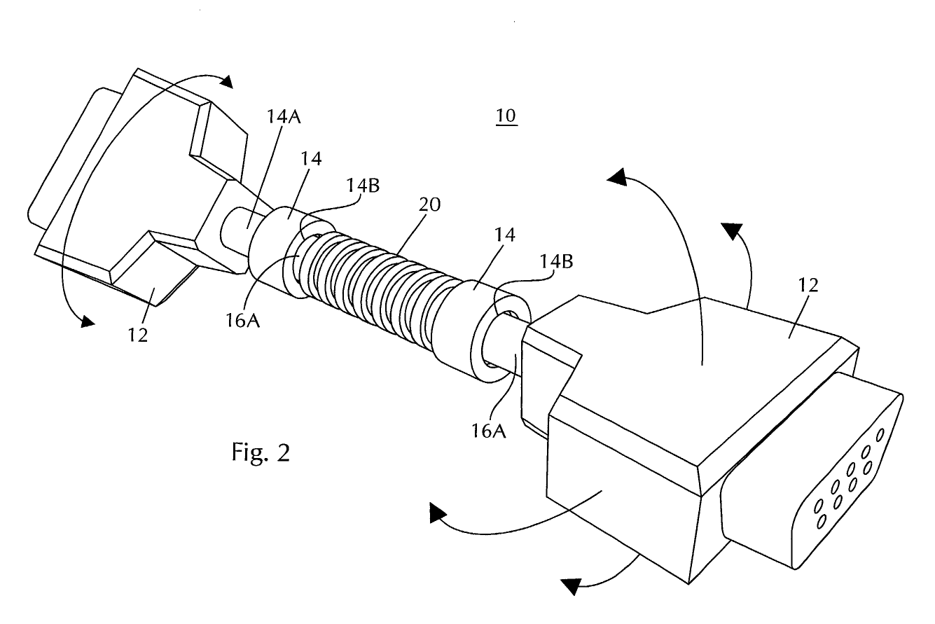

FIG. 2 is a three-quarter side perspective view of connection members in an assembled position, utilizing a semi-rigid member to accomplish both rotational movement of the connectors, as well as flexure, per the directional arrows located on the right side of the drawing.

### DETAILED DESCRIPTION OF THE PREFERRED EMBODIMENT

The first description relates to both FIG. 1, which is a three-quarter side perspective view of connection members in an assembled position, utilizing the rotation means of present invention, per the directional arrows located on the left side of the drawing, and FIG. 1A, which is a cutaway view of the connection members in an assembled position along line “1A” of FIG. 1. Generally, as reiterated in the claims section herein, the twistable connector device (10) for usage in connection with a computer system and peripheral devices, comprises a right connector and left connector (12).

The twistable connector device further comprises a retaining disc (within portion depicted as 14) integrated into a section of the twistable connector that is rear of the right connector or left connector (14A, 16A). The retaining disc functions to maintain connector integrity. Importantly, the retaining disc further functions to allow the left and right connectors to rotate along a horizontal axis with respect to one another. As such, the same allows the twistable connector device to function as an interface to allow a user to rotate one end of the connector, by twisting shaft (16A), for placement into a previously-determined receiving device.

To illustrate the versatility of the concept proposed herein, each of the right connector and left connector interface type are selected from the group consisting of 9DF, 9DM, 15DF, 15DM, 25DF, 25DM, USB, RJ45, BNC, Trompeter and Playstation. Further, it is important to note that the assembly may utilize a standard wiring type selected from the group consisting of RS-232, RS-422, RS-449, RS-485, GPIB, printer, IF/RF signaling, X.25, and other standards. Furthermore, the present invention's usage of standard materials will allow for ease in manufacturing and reduced costs.

FIG. 2 is a three-quarter side perspective view of connection members in an assembled position. In this embodiment, however, the invention utilizes an elongated, flexible or semi-rigid member (20) to affix the right connector and left connector to one another. This accomplishes both rotational movement of the connectors, as well as flexure, per the directional arrows located on the right side of the drawing. As claimed, the assembly may utilize at least one such extension member, which functions to allow a semi-rigid plastic member between the connections to a previously-determined length for the purposes of user convenience. In preferred modes, the elongated, flexible, semi-rigid member is of a length selected from a range of one foot to ten feet. In addition, the elongated, flexible, semi-rigid member may be corrugated in configuration.

The assembly depicted herein may also utilize a particular provider device. In the preferred mode, such provider device comprises a base and multiple sides. The provider device functions to receive one connector end of the twistable connector device described above, and further functions to service up a plurality of interface ports. Such allows a user to connect a plurality of previously-determined peripheral devices to the provider device in a compact and convenient manner.

More particularly, the provider device is generally semi-spherical in configuration, and comprises a flat bottom surface. For the purposes of example, one connector end of the twistable connector device may engage the provider device through usage of a 25 DF connector. However, one connector end of the twistable connector device may engage the provider through usage of additional means, such as a 50 DF connector. Similarly with regards to versatility, the base of the provider device functions as a type selected from the group consisting of 4 port extension, USB hub, LAN hub, and Playstation connection.

In enhanced modes, the provider device bears previously determined indicia or graphics thereon. For the purposes of example only, the indicia may comprise graphics in the general appearance of an eyeball, consistent with the shape and overall configuration of the provider as stated above.

Regarding its convenience and other functional aspects, the flat bottom surface of the provider device comprises a fastening means thereon. The fastening means functions to allow the user to affix the provider device to a flat surface for secure placement thereof. For instance, the fastening means may consist of at least one suction cup, which functions to allow the user to easily affix the provider to a desk or wall surface.

Finally, it is also important to note that a plurality of such provider devices may be used in conjunction with one another in a single system. Under such a configuration, the aforementioned graphics and indicia may provide particular amusement to the user, enhancing the overall appearance of the system in question.

With regards to all FIGURES, while the invention has been illustrated and described as embodied, it is not intended to be limited to the details shown, since it will be understood that various omissions, modifications, substitutions and changes in the forms and details of the device illustrated and in its operation can be made by those skilled in the art without departing in any way from the spirit of the invention.

Without further analysis, the foregoing will so fully reveal the gist of the present invention that others can readily adapt it for various applications without omitting features that, from the standpoint of prior art, constitute essential characteristics of the generic or specific aspects of this invention. What is claimed as new and desired to be protected by Letters Patent is set forth in the appended claims.

What is claimed is:

1. A twistable connector device for usage in connection with a computer system and peripheral devices, the twistable connector device comprising a right connector and left connector, the right connector and left connector affixed to one another by an elongated, flexible, semi-rigid member, the twistable connector device further comprising a retaining disc integrated into a section of the twistable connector that is rear of the right connector or left connector, the retaining disc functioning to maintain connector integrity, the retaining disc further functioning to allow the left and right connectors to rotate along a horizontal axis with respect to one another, allowing the twistable connector device to function as an interface to allow a user to rotate one end of the connector for placement into a previously determined receiving device.

2. The twistable connector device as described in claim 1, wherein each of the right connector and left connector interface type are selected from the group consisting of 9DF, 9DM, 15DF, 15DM, 25DF, 25DM, USB, RJ45, BNC, Trompeter and Playstation.

3. The twistable connector device as described in claim 1, wherein the assembly utilizes a standard wiring type selected from the group consisting of RS-232, RS-422, RS-449, RS-485, GPIB, printer, IF/RF signaling, X.25, and other standards.

4. The twistable connector device as described in claim 1, wherein the assembly utilizes at least one extension member which functions to allow a semi-rigid plastic member between the connections to a previously-determined length for the purposes of user convenience.

5. The twistable connector device as described in claim 1, wherein the assembly utilizes standard materials to allow for ease in manufacturing and reduced costs.

6. The twistable connector as described in claim 1, wherein the assembly utilizes a provider device, the provider device comprising a base and multiple sides, the provider device functioning to receive one connector end of the twistable connector device, and further functioning to service up a plurality of interface ports, allowing a user to connect a plurality of previously determined peripheral devices to the provider device in a compact and convenient manner.

7. The twistable connector as described in claim 6, wherein the provider device is generally semispherical in configuration, and comprises a flat bottom surface.

8. The twistable connector as described in claim 6, wherein one connector end of the twistable connector device engages the provider device through usage of a 25 DF connector.

9. The twistable connector as described in claim 6, wherein one connector end of the twistable connector device engages the provider through usage of a 50 DF connector.

10. The twistable connector as described in claim 6, wherein the base of the provider device functions as a type selected from the group consisting of 4 port extension, USB hub, LAN hub, and Playstation connection.

11. The twistable connector as described in claim 6, wherein the provider device bears previously determined indicia thereon.

12. The twistable connector as described in claim 11, wherein the indicia comprises graphics in the general appearance of an eyeball.

13. The twistable connector as described in claim 6, wherein the flat bottom surface of the provider device comprises a fastening means thereon, the fastening means functioning to allow the user to affix the provider device to a flat surface.

14. The twistable connector as described in claim 13, wherein the fastening means is at least one suction cup.

15. The twistable connector as described in claim 1, wherein the elongated, flexible, semi-rigid member is of a length selected from a range of one foot to ten feet.

16. The twistable connector as described in claim 1, wherein the elongated, flexible, semi-rigid member is corrugated.

17. The twistable connector as described in claim 6, wherein a plurality of provider devices are used in conjunction with one another in a single system.
